(19) United States
(12) Patent Application Publication
(10) Pub. No.: US 2001/0052911 A1
(43) Pub. Date: Dec. 20, 2001

(54) System and Method for image capture and management in an electronic device

(76) Inventors: Dennis Boyle, Palo Alto, CA (US); Erich Ian Domingo, Hayward, CA (US); Leo Kopelow, Palo Alto, CA (US); Daniel Stillion, Mountain View, CA (US); Arthur J. Dahm III, Ardsley, NY (US)

Correspondence Address: CARR & FERRELL LLP, 2225 EAST BAYSHORE ROAD, SUITE 200, PALO ALTO, CA, 94303, US

(21) Appl. No.: 09/757,179

(22) Filed: Jan. 8, 2001

Related U.S. Application Data
(60) Provisional application No. 60/175,056, filed on Jan. 7, 2000.

(51) Int. Cl. G09G 5/02; G09G 5/00

(52) U.S. Cl. 345/763

(57) ABSTRACT

A system and method for capturing and managing live images in a digital format on an electronic device in a manner that is easy, intuitive and useful is provided. The system and method includes an image management engine and graphical user interface that allows a user to manage, manipulate, edit and store the images in the electronic device. Additionally, the invention provides a method of transmitting images thus captured and stored to a remote device.

### CROSS-REFERENCES TO RELATED APPLICATIONS

This application claims the benefit of Provisional Patent Application Ser. No. 60/175,056, filed on Jan. 7, 2000, entitled “Digital Camera Accessory Module System,” which is incorporated herein by reference. This application is also related to co-pending application, Ser. No.______, entitled “Image Capture Module For Use On An Electronic Device” filed on Jan. 8, 2001, which is incorporated herein by reference.

### BACKGROUND OF THE INVENTION

1. Field of the Invention

The present invention relates generally to electronic imaging, and more particularly to a graphical user interface and method for capturing and managing images with an image acquisition module connected to an electronic device.

2. Description of Related Art

The use of electronic imaging devices is increasing in popularity. Typically, a video camera in conjunction with a computer frame grabber is used to capture still images to a computer or similar processing device. Another approach to computer image acquisition is through the use of digital cameras.

However, these methods require a user to capture images on one device, a digital camera for example, and manually transfer the captured images to a computer for storage, retrieval, manipulation and management. They require the user to employ several hardware devices and several intermediate hardware and/or software steps to view, capture and manage images.

Furthermore, as the technology of handheld electronic devices advances, users will require a method to transmit captured images to other devices in a wireless and portable fashion. Because of the decreasing size and increasing power of such handheld devices, it is important to the user to capture and manage images with as little user intervention as possible and without cumbersome hardware and/or complex software.

With the growing development and popularity of portable electronic devices, such as Personal Digital Assistants (PDAs), accessory modules to PDAs have become more sophisticated. Consequently, there is an increasing need to provide intuitive user interfaces to the software that power these devices. Therefore, a current need exists for a user-friendly graphical user interface for use with electronic devices, such as handheld and/or wireless devices, for the capture, management and transmission of images and a method for doing the same.

### SUMMARY OF THE INVENTION

The present invention provides a system and method for capturing live images in a digital format to an electronic device in a manner that is easy, intuitive and useful. The invention provides a graphical user interface for use with an image capture device. The graphical user interface allows a user to manage, manipulate, edit and store the image either in the handheld electronic device, such as a PDA, or in a remote storage device, such as a computer hard drive.

Accordingly, the present invention provides a fast, flexible and easy method of capturing and managing live images on an electronic device. Moreover, the invention is a single, integrated computing system and a method providing an easy-to-use graphical user interface that can quickly and easily capture and manage images. Other advantages, features and embodiments of the present invention will be apparent from the drawings and detailed description as set forth below.

### BRIEF DESCRIPTION OF THE DRAWINGS

FIG. 1 is a schematic diagram of an electronic device with an image capture module attached thereto, according to the present invention;

FIG. 2A shows an exemplary display of an electronic device;

FIG. 2A shows an exemplary diagram of an image management engine;

FIG. 3 is an exemplary diagram of a user interface screen for capturing and viewing images;

FIG. 4 is another exemplary diagram of a user interface screen for capturing and viewing images;

FIG. 5 is an exemplary diagram of a timer menu for automatic image capture;

FIG. 6 is an exemplary diagram of a user interface screen for viewing and transmitting images;

FIG. 7A is an exemplary diagram of an image detail menu;

FIG. 7B is an exemplary diagram of a notes menu; and

FIG. 8 is an exemplary diagram of a user interface screen for viewing a textual list of images according to the present invention.

### DESCRIPTION OF THE PREFERRED EMBODIMENT

The present invention is described in the context of a graphical user interface and method for capturing and managing images on an electronic device. In its preferred embodiment, the invention is an image management engine and graphical user interface that is downloaded from a digital camera accessory module to an electronic device that can store, retrieve, and/or display data in the form of text, graphics and/or images, such as handheld computers, cell phones, or personal digital assistants (PDA). The image management engine provides a user with the tools necessary to capture, view, store, manipulate, format, categorize, and transmit images from a digital camera accessory module to the electronic device. The image management engine also provides interfaces to the image capture device that allow the image management engine to control the behavior of the image capture device, such as determining when, how often and in what format the image data is acquired. Those skilled in the art will appreciate that this application is merely exemplary and that various aspects of the invention may be implemented in other areas where it is desired to capture and manage images with an electronic device.

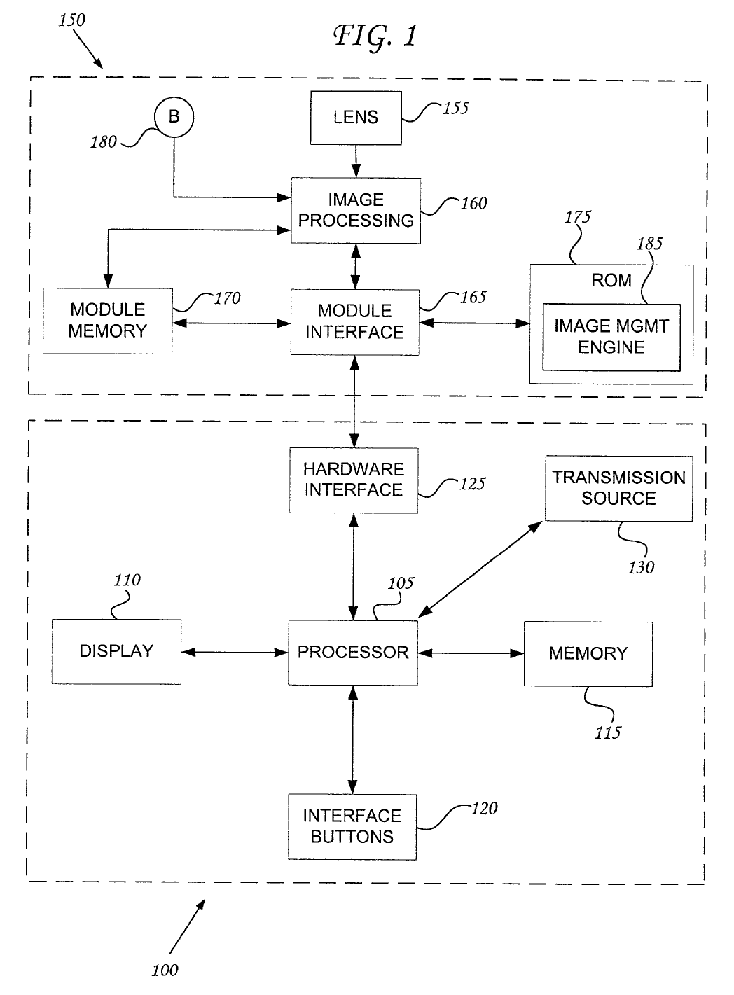

FIG. 1 shows a schematic diagram of an electronic device 100 coupled to an image capture module 150. The electronic device 100 preferably includes a processor 105, a display 110, a memory 115, a plurality of interface buttons 120, a hardware interface 125, and an image transmission source 130. The image capture module 150 comprises a lens 155, an image-processing chip set 160, a module interface 165, a module memory 170, a ROM 175, and an image capture button 180. The module interface 165 of the image capture module 150 mechanically plugs into and is electrically compatible with the hardware interface 125 of the electronic device 100. Thus, communications and transfer of electronic data between the image capture module 150 and the electronic device 100 is accomplished.

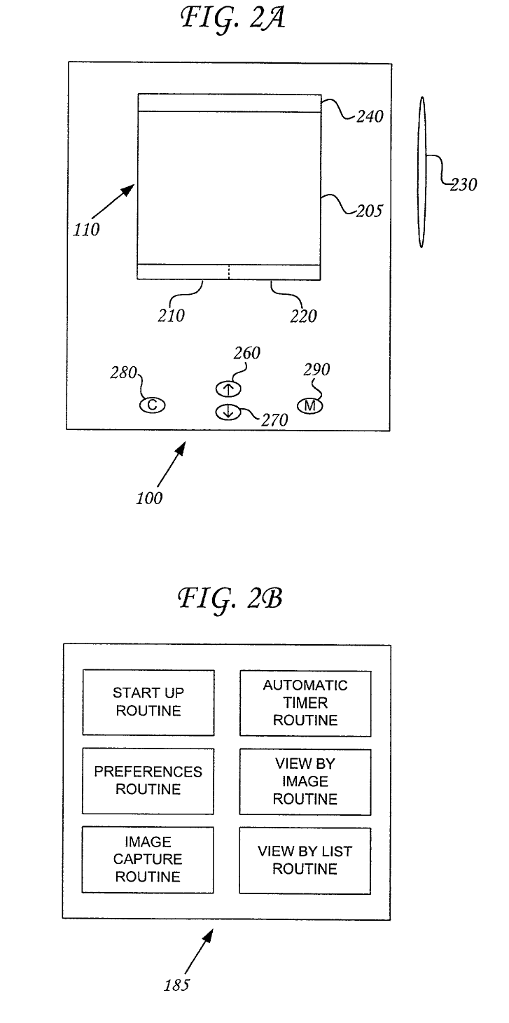

In the preferred embodiment, an image management engine 185 is stored in the ROM 175 of the image capture module 150. In alternate embodiments, the image management engine 185 may be provided on magnetic or optical media. The image management engine 185 includes one or more image management routines, or modes, discussed in more detail below in relation to FIG. 2B. In the preferred embodiment, once the connection between the module interface 165 and hardware interface 125 is established, the image-processing chip set 160 sends an interrupt to the processor 105, instructing the processor 105 to download the image management engine 185 from the ROM 175 to the memory 115 of the electronic device 100. The processor 105 then runs the image management engine 185 from the memory 115, which establishes a command and control interface between the processor 105 and the image capture module 150 and causes a series of graphical icons and textual messages to appear on various areas of the display 110 as a graphical user interface. In alternate embodiments where the image management engine 185 is provided on other computer readable media, the image management engine 185 is loaded from the medium directly to the memory 115 and the processor 105 runs the image management engine 185.

FIG. 2A shows an exemplary embodiment of the electronic device 100. In this embodiment, the electronic device 100 includes a selection tool 230. The display 110 also preferably includes an image display area 205, a lower left display area 210, a lower right display area 220 and an upper display area 240, all fixed in predetermined sections of the display 110. The image captured by the image capture module 150 is displayed in the image display area 205. The other sections of display 110 are used to display text and graphical icons created by the image management engine 185 that the user may execute by touching the icon with the selection tool 230.

In the preferred embodiment, the interface buttons 120 (FIG. 1) consist of a scroll-up button 260, a scroll-down button 270, a capture button 280 and a menu button 290. These buttons are used to provide additional means to execute the routines of the image management engine 185, discussed below in connection with FIG. 2B. Although FIG. 2A shows a preferred embodiment of four interface buttons arranged in a preferred configuration, any number of buttons arranged in alternate configurations and naming conventions may be contemplated.

FIG. 2B shows an exemplary embodiment of the image management engine 185 of FIG. 1. The image management engine 185 includes one or more routines, or modes, for performing various image management tasks. The user selects and executes a specific routine corresponding to a specific task to be performed. The routines of the preferred embodiment are described below.

The image capture module 150 captures a live image by acquiring an optical image of reflected light through the lens 155 (FIG. 1). The optical image is then sent to the image-processing chip set 160 (FIG. 1), which performs an analog to digital conversion of the image. Optionally, the image-processing chip set 160 can perform one or more available image processing functions in order to make the image compatible with the viewing and/or storage capabilities of the electronic device 100. As described above, the image management engine 185 then runs, providing graphical icons and textual messages that appear on sections of the display 110 guiding the user through a multitude of options and modes with which to capture and manage the images (see FIG. 2B).

Menu Bar Items

In the preferred embodiment, referring again to FIG. 2A, the upper display area 240 of the display 110 presents a menu bar when the menu button 290 of the electronic device 100 is pressed. The menu bar can access help features, computer version numbers, software version information, or the like. It can also be used to group images for group delete and group transmit functions, thus enabling multiple image deletion or transmission at the same time. The menu bar features may be executed using the selection tool 230.

Start Up Mode

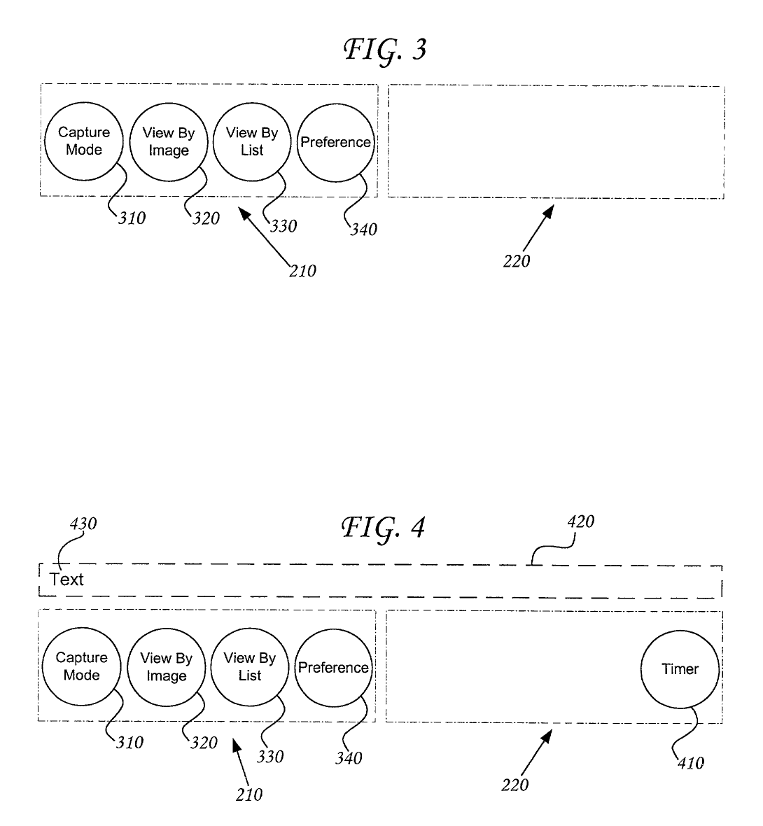

When the image management engine 185 initializes, the display 110 presents a start-up screen. FIG. 3 shows a schematic representation of an exemplary start-up display consisting of various graphical icons. Preferably, these graphical icons appear on the lower left display area 210. In one embodiment of the invention, this graphical icon display consists of a capture mode icon 310, a view by image icon 320, a view by list icon 330 and a preference icon 340. While in this mode, a user may at any time hide the entire icon display by manually pressing the menu button 290 of the electronic device 100 of FIG. 1. Upon pressing the menu button 290 again, the icon display will reappear. Any icon displayed on the lower left display area 210 may be selected and executed by touching the selection tool 230 of FIG. 2A to the icon of interest.

Preferences

The user may execute a preference mode of the electronic device 100 by touching the preference icon 340 with the selection tool 230. In this mode, the user selects from a series of options and personal preferences the manner in which the electronic device 100 manages images. In the preferred embodiment, the display 110 presents the user with a plurality of options, including image formatting, image resolution, sounds, categories, capture options and back-up features.

Image-Capture Mode

The user can put the image management engine 185 into an image-capture mode by selecting the capture mode icon 310 with the selection tool 230 or pressing the capture button 280 on the electronic device 100 (FIG. 2A). A live image from the image capture module 150 is displayed on the image display area 205 of the display 110 of FIG. 2A.

When the image management engine 185 is in the image capture mode, the user may wish to capture or freeze the image displayed on the image display area 205 into a still frame image. In the preferred embodiment, the live image shown on the image display area 205 can be framed and frozen as a still image by pressing the capture button 280 or the scroll-up button 260 of the electronic device 100 (FIG. 2A), or by pressing the image capture button 180 of the image capture module 150 (FIG. 1).

Upon freezing the image, and referring to FIG. 4, a textual message 430 appears in a text display area 420 above the lower left display area 210 and the lower right display area 220. In an exemplary embodiment, the textual message 430 will inquire whether the user wishes to save the captured image to the memory 115 (FIG. 1). Pressing the capture button 280 or the scroll-up button 260 causes the image to be saved to the memory 115. Pressing the scroll-down button 270 (FIG. 2A) will not save the image to the memory. In either event, the electronic device 100 then reverts to a view of the live image from the image capture module 150.

The textual message 430 can alert the user to a variety of pertinent information regarding the image capture status of the electronic device 100. For example, the textual message 430 appearing on the text display area 420 can inform the user whether the image being saved is in color, grayscale, black-and-white or any other format; it can alert the user that the memory 115 (FIG. 1) has insufficient capacity remaining to store further images. A number of other informative and useful textual messages 430 can be imagined and implemented by way of the text display area 420.

Automatic Timer Mode

While in the image-capture mode, referring again to FIG. 4, a timer icon 410 appears on the lower right display area 220. As it first appears, the timer icon 410 is displayed as a static symbol. Selecting the timer icon 410 with the selection tool 230 causes the image management engine 185 to execute an automatic timer mode and will present the user with one or more options to automate the image capture process.

FIG. 5 shows an exemplary embodiment of a timer menu 510 that appears when the automatic timer mode is thus activated. The timer menu 510 presents the user with several automatic timing options. In an exemplary embodiment, the timer menu 510 contains a default timer 520 and a programmable timer 530. Using the default timer 520, the user may choose, upon activation of a single button or icon, to automatically capture an image at a default time delay preset by the image management engine 185. Thus, if the image management engine 185 is preset by default to capture an image in ten seconds, the image management engine 185 will automatically capture an image ten seconds after the user activates the appropriate button or icon.

Using the programmable timer 530, a user can program both the number of images to be captured and the time that must elapse between each capture, thus expanding the flexibility of the automatic timing mode to accommodate a wide range of image and time choices. Images captured in the automatic timer mode may be saved into the memory 115 (FIG. 1) or may be deleted, at the user's discretion. A number of other automatic timing options can be imagined and implemented by way of the timer menu 510 of FIG. 5.

After the user sets the desired automatic timing options as described above, the timer menu 510 is replaced on the display 110 by a live image from the image capture module 150 (FIG. 1). In an exemplary embodiment, as the image management engine 185 executes the automatic timing options selected, the timer icon 410 of FIG. 4 changes from a static symbol to an animated symbol, alerting the user that the automatic timing options are running. Preferably, the timer icon 410 appears as an animated clock with continuously rotating hands. The animation of the timer icon 410 stops when the execution of the automatic timing options have been completed, at which time the timer icon 410 returns to a static symbol display.

If the electronic device 100 (FIG. 1) ever goes to “sleep” (reverts to a power-saving state) while the image management engine 185 is in the automatic timer mode, the selected timing function will continue to run and the program will cause the electronic device 100 to “wake up” from sleep at the appropriate time and capture the images in the manner set by the user.

View-By-Image Mode

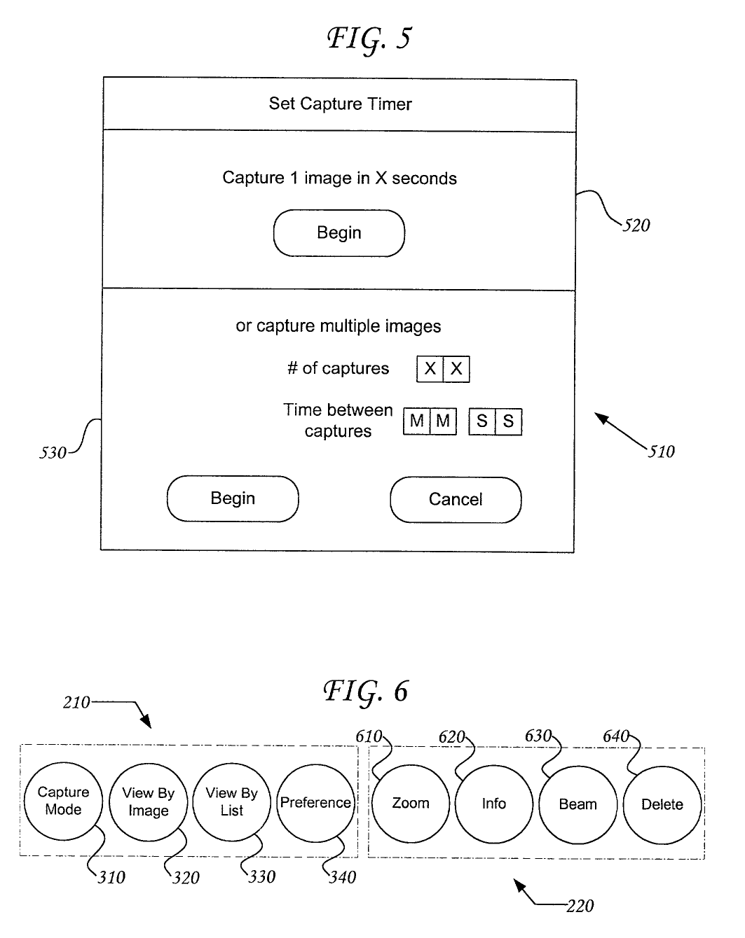

The user can put the image management engine 185 (FIG. 1) into a view-by-image mode by selecting the view by image icon 320 (FIG. 3) with the selection tool 230 (FIG. 2A). FIG. 6 is an exemplary view of the lower left display area 210 and the lower right display area 220 when the view-by-image mode is thus activated. In this mode, the lower right display area 220 contains an arrangement of graphical icons, preferably comprising a zoom icon 610, an info icon 620, a beam icon 630 and a delete icon 640. Each of the icons on the lower right display area 220 can be individually selected and executed using the selection tool 230 of FIG. 2A.

When the image management engine 185 executes the view-by-image mode, the image display area 205 (FIG. 2A) shows the last image saved in the memory 115 (FIG. 1). The user can then scroll through and view images saved in the memory 115 by preferably pressing either the scroll-up button 260 or the scroll-down button 270 of FIG. 2A. Successive stored images are thereby viewed on the image display area 205 (FIG. 2A). In an exemplary embodiment, the viewed image scrolls off to the right of the image display area 205 as the next saved image scrolls in from the left. Alternately, the viewed image may scroll off to the left, to the top or to the bottom of the image display area 205 followed by the next saved image (see FIG. 2A).

Upon selecting the zoom icon 610 of FIG. 6 with the selection tool 230 of FIG. 2A, or alternatively by touching the image displayed on image display area 205 with the selection tool 230, the image will be shown on the image display area 205 at either its original size or a predetermined multiple or fraction of its original size. The displayed image can be further enlarged or reduced by subsequently touching the image with the selection tool 230. As the image is enlarging (or zoomed), the image may become too large to be fully displayed on the display 110. Therefore, in an exemplary embodiment, the user can pan across the image by dragging the selection tool 230 across the displayed image in the direction of interest, thereby viewing the missing portions of the image.

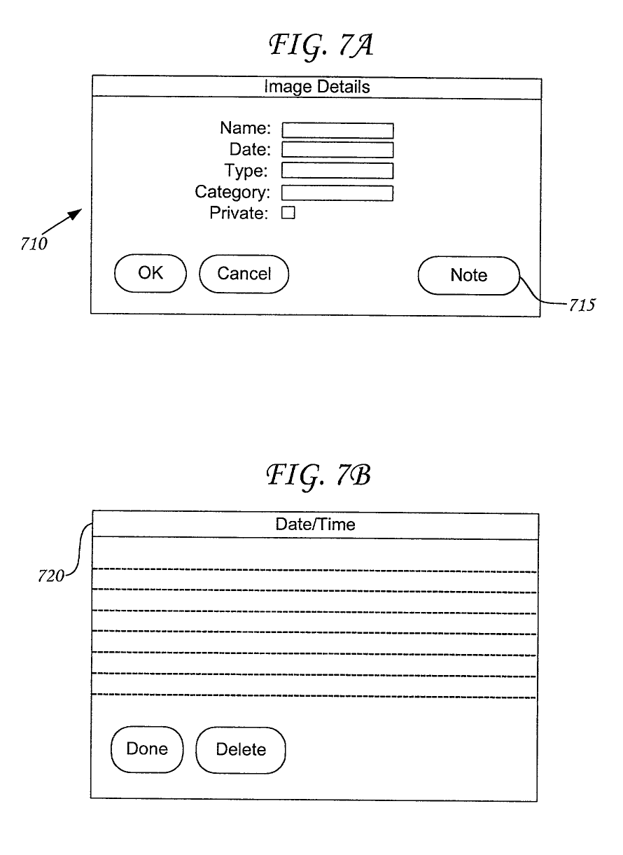

Selecting the info icon 620 with the selection tool 230 allows the user to view, edit, and save details of the displayed image to the memory 115 (FIG. 1). In an exemplary embodiment, selection of the info icon 620 presents an image detail menu 710, as shown in FIG. 7A, on the display 110 (FIG. 1). The image detail menu 710 preferably presents the user with a multitude of data entry fields relating to the image. Preferably, the electronic device 100 automatically fills in some of the data fields, but the user may edit these entries at any time. After the data is entered in the image detail menu 710, it is stored along with the image itself in the memory 115 (FIG. 1). In an exemplary embodiment, data such as name, date, image type, user-defined image category and security settings can be entered and stored.

The image detail menu 710 preferably comprises a note function, which is activated by selecting the note icon 715 in the image detail menu 710. Selecting the note function thus presents a notes menu 720, as shown in FIG. 7B. In the notes menu 720, the user may view, enter, and edit free form alphanumeric textual annotations related to the displayed image, which will then be stored in the memory 115 of FIG. 1 along with the data from the image detail menu 710 and the image itself.

Referring back to FIG. 6, the image management engine 185 (FIG. 1) allows the user to transmit a selected image from the electronic device 100 (FIG. 1) to a remote device, such as a storage device or another electronic device, through either a wired or wireless transmission means. To do this, the user selects the beam icon 630. In an exemplary embodiment, the transmission of image data is accomplished through infrared transmissions from the transmission source 130 (FIG. 1) of the electronic device 100 to a compatible infrared receiving source on the remote device. For example, if the electronic device 100 is a handheld PDA, the image can be sent by infrared transmission (i.e. “beamed”) to another handheld PDA.

Referring again to FIG. 6, the image management engine 185 also allows a user to delete a selected image from the memory 115 (FIG. 1) by selecting the delete icon 640.

View-By-List Mode

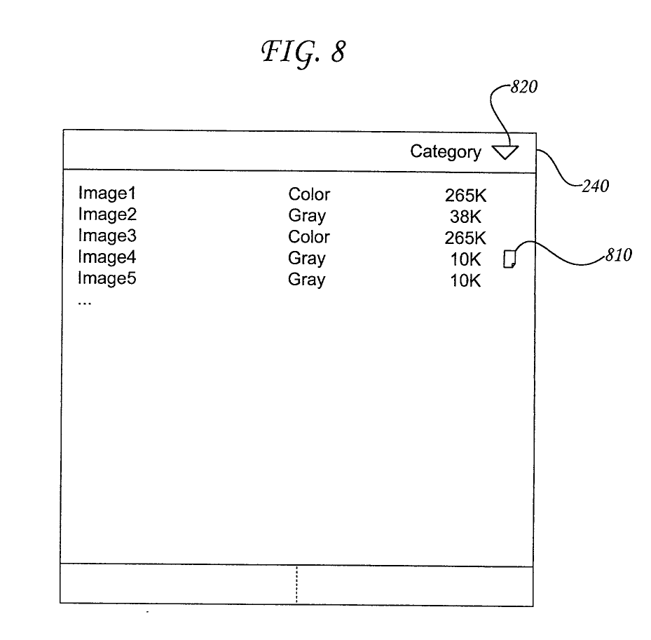

The user can put the image management engine 185 (FIG. 1) into a view-by-list mode by selecting the view by list icon 330 (FIG. 3) with the selection tool 230 of FIG. 2A. FIG. 8 shows an exemplary embodiment of the display 110 (FIG. 1) in a view-by-list mode. In this mode, the user can browse through an alphanumeric listing of image files in various user-defined categories that are organized and stored in the memory 115 (FIG. 1). In an exemplary embodiment, the view-by-list mode will present the user with a listing of all saved images sorted by name, and can also list other data relating to the saved images, such as image type, amount of memory used, date and time stored, and category. When in the view-by-list mode, the user may select a listed image by touching the listed image with the selection tool 230. Once selected, the image is retrieved from the memory 115, the electronic device 100 (FIG. 1) switches to the view-by-image mode described above, and the selected image appears on the display 110.

In the exemplary embodiment, a data icon 810 appears next to the listing of each saved image in which notes were saved according to the method described above in the view-by-image mode. The user can view the associated notes by selecting the data icon 810, causing the display 110 to revert to the notes menu 720 of FIG. 7B.

Referring again to FIG. 8, the upper display area 240 will present a category pull-down menu 820 when the electronic device 100 is in the view-by-list mode. The category pull-down menu 820 allows a user to select from a list of categories using the selection tool 230. The display categories are defined by the user and stored in the image detail menu 710 of FIG. 7A while in the view-by-image mode. Examples of categories may include family, business, friends and personal. When a category is thus selected from the category pull-down menu 720, the display 110 shows only a list of the images saved in that category. New categories may also be created in the view-by-list mode.

As preferred embodiments of the present invention are described above with reference to the aforementioned drawings, various modifications or adaptations of the methods and or specific structures described may become apparent to those skilled in the art. For example, selection of icons may be performed using the selection tool 230 (FIG. 2) or using the interface buttons 120 (FIG. 1). All such modifications, adaptations, or variations that rely upon the teachings of the present invention, and through which these teachings have advanced the art, are considered to be within the spirit and scope of the present invention. Hence, these descriptions and drawings are not be considered in a limiting sense as is understood that the present invention is in no way limited to the embodiments illustrated.

What is claimed is:

1. A machine-readable medium having embodied thereon an image management program, the program being executable by an electronic device to perform method steps for capturing, controlling and managing an image, the method steps comprising:
receiving an image from an image capture device coupled to the electronic device;
managing the display of the image on a display screen constituent to the electronic device;
managing the display of a graphical user interface on the display screen, the user interface comprising at least one interactive icon, the interactive icon being capable of executing a routine within the program upon activation of said icon by a user.

2. The machine-readable medium of claim 1, further comprising the step of controlling one or more operational modes of the image capture device.

3. The machine-readable medium of claim 1, further comprising the step of transmitting said image from said electronic device to a remote device.

4. The machine-readable medium of claim 1, wherein said program is transferred from the image capture device to the electronic device for execution.

5. The machine-readable medium of claim 1, wherein said program is transferred from an external magnetic medium to the electronic device for execution.

6. The machine-readable medium of claim 1, wherein said program is transferred from an external optical medium to the electronic device for execution.

7. The machine-readable medium of claim 1 wherein said electronic device is a handheld device.

8. A system for capturing and managing images, comprising:
an electronic device, further comprising:
a processor,
a display, for selectively displaying text and one or more live or stored images, and
a memory, for storing said images;
an image capture device removably attached to said electronic device; and
an image management engine loaded into said memory and executed by said processor, the image management engine capable of implementing a plurality of functions for capturing, managing and viewing said images.

9. The system of claim 8, wherein said electronic device further comprises a transmission source for transmitting image data from said electronic device to a remote device.

10. The system of claim 9, wherein said transmission source is wireless.

11. The system of claim 10 wherein said wireless transmission source is infrared.

12. The system of claim 8 wherein said image capture device is a digital camera.

13. The system of claim 8 wherein said image management engine is loaded into said memory from an external magnetic medium.

14. The system of claim 8 wherein said image management engine is loaded into said memory from an external optical medium.

15. The system of claim 8 wherein said image capture device comprises an internal memory.

16. The system of claim 15 wherein said image management engine is pre-loaded in said internal memory of said image capture device.

17. The system of claim 16 wherein said image management engine is automatically downloaded and stored in said memory of said electronic device upon attachment of said image capture device to said electronic device.

18. The system of claim 8 wherein said image management engine presents one or more graphical user interface icons on said display of said electronic device to facilitate capture or management of images.

19. A method for managing live images on an electronic device, comprising the steps of:
providing a display for viewing said images on said electronic device;
providing a camera for capturing said images; and
providing one or more image control functions that execute by selecting same.

20. The method of claim 19 further comprising the step of providing a memory to store said image after capturing.

21. The method of claim 19 wherein said image is captured by said camera by programming an automatic timer.

22. The method of claim 21 wherein said image is captured by programming said automatic timer to capture said image within a user-specified time.

23. The method of claim 21 wherein an image is captured by programming said automatic timer to capture a user-specified number of images at a user-specified time interval.

24. The method of claim 19 further comprising the step of providing a transmission source for transmitting selected image data to a remote device after capturing.
